(19) United States
(12) Patent Application Publication
(10) Pub. No.: US 2025/0381991 A1
(43) Pub. Date: Dec. 18, 2025

(54) OPERATING A VEHICLE WITH AN INCREASED LEVEL OF AUTOMATION

(71) Applicant: Ford Global Technologies, LLC, Dearborn, MI (US)

(72) Inventors: Mohsen Lakehal-ayat, Aachen/NRW (DE); Mohamed Benmimoun, Köln/NRW (DE); Ahmed Benmimoun, Aachen/NRW (DE); Muhammad Adeel Awan, Aachen/NRW (DE)

(73) Assignee: Ford Global Technologies, LLC, Dearborn, MI (US)

(21) Appl. No.: 19/240,334

(22) Filed: Jun. 17, 2025

(30) Foreign Application Priority Data
Jun. 18, 2024 (DE) 102024117055.7

(51) Int. Cl. B60W 60/00; B60W 50/14; G01C 21/00; G01C 21/34; H04W 4/029

(52) U.S. Cl. CPC B60W 60/0051; B60W 50/14; B60W 60/0015; B60W 60/0053; G01C 21/3453; G01C 21/3804; H04W 4/029; B60W 2556/45

(57) ABSTRACT

Operating a vehicle which has an established level of automation includes: starting an online navigation system with a level of automation which is higher than the level of automation of the vehicle; ascertaining, retrieving, and displaying available geographic zones in which navigation with a higher level of automation is available; if the vehicle is located in an ascertained geographic zone in which navigation with the higher level of automation is available, activating the online navigation system having a higher level of automation; starting navigation of the vehicle with a higher level of automation, wherein data of the online navigation system are used.

### CROSS-REFERENCE TO RELATED APPLICATION

This patent application claims priority to German Application No. DE 102024117055.7 filed on Jun. 18, 2024, which is hereby incorporated by reference in its entirety.

### FIELD

The present disclosure relates to a method for operating a vehicle, and to a control device implementing a method for operating a vehicle, and includes providing a an online streaming platform. The method can be a computer-implemented method.

### BACKGROUND

Needs for equipping vehicles with advanced capabilities for semi-autonomous or autonomous driving are constantly increasing. However, the computer resources and computing-power resources of vehicles are limited by available hardware.

In the future, more and more vehicles will be equipped with advanced technology, which will lead to an increased diversity of computational abilities and sensor capabilities on the roadways, wherein highly equipped vehicles and only slightly equipped vehicles are present at the same time. In such a situation, large amounts of data which can accurately model the vehicle surroundings may be generated by the highly equipped vehicles using their high computational abilities and sensor capabilities.

An autonomous vehicle is herein to be understood to mean a vehicle which is designed to navigate using little or no user input. For this purpose, the vehicle detects its surroundings by means of suitable sensors, for example, cameras, radar sensors, LiDAR sensors, or the like. In addition, data from positioning systems such as global positioning systems (GPS), navigation systems, vehicle-to-vehicle communication, vehicle-to-infrastructure technology, and drive-by-wire systems, are used.

At the moment, vehicle automation is classified into numerical levels from zero (L0) to five (L5). Level zero automation means that no automation is provided, i.e., the vehicle is controlled entirely by the driver. At level 5 automation, full automation is provided and there is no control by the driver. The levels one through four of automation require certain vehicle assistance systems.

For certain applications, the use of reliable and trusted information either from a local source or from a cloud service is helpful. In situations in which the hardware capabilities are limited, there is a need for an improved offering of connectivity in order to move certain applications to a cloud. In this context, crowdsourcing can make all necessary information available.

For example, a vehicle can be equipped with a sensor system for L3 operation, although the vehicle may be subjected to an associated speed limitation. In order to operate this level of automation at a higher speed, additional information would be necessary that cannot be sufficiently collected using the existing vehicle sensor system.

Documents DE 10 2022 111 334 A1 and DE 10 2022 111 691 A1 describe systems and methods for an on-demand autonomy service, wherein a leader vehicle and a follower vehicle are interconnected via a server and the follower vehicle is controlled by the leader vehicle.

According to document US 2020/0365029 A1, a vehicle includes a memory configured to store a dynamic occupancy grid of observed objects within a space surrounding the vehicle, wherein the grid is generated on the basis of information collected by sensors of the vehicle and wirelessly connected vehicles or infrastructure elements. The dynamic occupancy grid is used to identify obstacles within an intended maneuver space.

In document U.S. Pat. No. 10,816,346 B2, an online system builds a high definition (HD) map for a geographic region. This is carried out on the basis of sensor data of a plurality of autonomous vehicles driving through the corresponding region. The online system updates existing occupancy maps and improves the reliability of the occupancy maps.

### SUMMARY

Against this background, the present disclosure provides advantageous method for operating a vehicle which has an established level of automation. Further, an advantageous control device can be provided for the at least semi-automated operation of a vehicle., Further, an online streaming platform and/or a computer-implemented method can be provided.

The method according to the disclosure for operating a vehicle which has an established level of automation, for example, L2 or L3, or is equipped with same, includes the following steps: In a first step, an online-provided or online-available, for example, cloud-based, navigation system with a level of automation which is higher than the level of automation of the vehicle is started. In other words, the online-provided or online-available navigation system is designed to navigate a vehicle with a higher level of automation (for example, L3 or L4) than that which corresponds to the vehicle equipment (for example, L2). In order to start the online-provided or online-available navigation system, a data connection to the navigation system is preferably established.

In a second step, geographic zones or regions, i.e., AV zones, which are available in the navigation system and in which navigation, for example, online-based navigation, with a higher level of automation is available, are ascertained, retrieved, and displayed. If the vehicle is located in an ascertained geographic zone or an ascertained region in which navigation with a higher level of automation is available, i.e., for example, in an AV zone suggested by the navigation system, in a third step, the online-provided or online-available, for example, cloud-based, navigation system with a higher level of automation than that of the vehicle is activated.

Subsequently, in a fourth step, navigation of the vehicle with a, for example, determined or established, higher level of automation is started, wherein data of the online navigation system are used. In this context, data of the online navigation system can be accessed and/or retrieved.

The vehicle can be a motor vehicle, or alternatively a ship or an aircraft or a helicopter.

The method according to the disclosure has the advantage that it enables vehicles to be operated in certain areas with a level of automation which is higher than that provided by the vehicle equipment. This option considerably increases the comfort for users and enhances vehicle operation. For example, regardless of the level of automation of the vehicle equipment, the control interface which is necessary for operating a vehicle with an L2 level of automation can be comparable to a control interface which is necessary for operating at the L3 level of automation, i.e., at which steering, braking, and acceleration are carried out in an automated manner. Sharing or jointly using the data of the more highly equipped vehicle with a lesser equipped vehicle therefore makes it possible for the lesser equipped vehicle to operate at a higher level of automation. Even if the lesser equipped vehicle does not have the computational abilities and sensor capabilities required for this on board, it can be operated in the same way as a more highly equipped vehicle by using information provided by more highly equipped vehicles.

In an advantageous variant, the connection to the online navigation system, for example, the connection to a corresponding network cloud, is monitored. If the connection is interrupted, the driver of the vehicle can be prompted to take over the control of the vehicle according to the level of automation of the vehicle, and the navigation of the vehicle with the higher level of automation can be terminated and/or deactivated. This variant can achieve effective utilization of an operation of the vehicle with an increased level of automation. In this context, it may be ascertained, for example, detected, whether the driver takes over control and, if the driver does not take over the control, at least one established emergency maneuver can be started.

In another variant, a route to a defined destination is ascertained, for example, calculated, which maximizes and/or optimizes a use of the navigation with a higher level of automation. This can be carried out by means of the online-provided and/or online-available, for example, cloud-based, navigation system. For example, a route can be ascertained, in which a maximum distance can be covered with a higher level of automation. This typically increases the comfort for users.

Current data regarding the immediate surroundings of the vehicle collected by the vehicle, for example, by means of existing sensors, can be transmitted to the online navigation system. The data can be uploaded, for example, to a cloud provided for this purpose. In this way, the navigation system is continuously updated and supplied with a multitude of data, as a result of which the reliability of the navigation system is improved.

In a variant, the vehicle is provided with data for navigating the vehicle with the higher level of automation, which data have been adapted to the vehicle by means of the online, for example, cloud-based, navigation system. This typically optimizes the user comfort and the reliability of the operation with the higher level of automation.

The control device according to the disclosure for the at least semi-automated operation of a vehicle which has an established level of automation or is equipped with same includes a device for exchanging data with an online, for example, cloud-based, navigation system and is designed to carry out an above-described method according to the disclosure. The control device according to the invention has the features and advantages which have already been described in this context.

The vehicle according to the disclosure has an established level of automation, for example, L2 or L3. The vehicle includes an above-described control device according to the disclosure or is designed for operation according to a method according to the disclosure for operating a vehicle. The vehicle has the above-described advantages. The vehicle can be an electric vehicle or a hybrid vehicle (HEV mean hybrid electric vehicle). The vehicle can be a motor vehicle, for example, a passenger car, a truck, a bus, a minivan, a motorcycle, or a moped. The vehicle can also be a ship or an aircraft or a helicopter.

The method according to the disclosure for providing, in particular for creating and operating, an online streaming platform which can be, for example, cloud-based, for use for an above-described method according to the disclosure or for a control device according to the disclosure is distinguished by the fact that data from vehicles and infrastructure sensors, for example, infrastructure sensor networks (infrastructure sensing network), are transmitted to the online streaming platform, dynamic, preferably global, occupancy maps are generated for roadways and their surroundings on the basis of the transmitted data, and the generated dynamic occupancy maps are provided, for example, on demand, to a vehicle for use, possibly within the scope of the autonomous navigation. In this context, data from pedestrians, cyclists, or other road users can also be collected and used. The method and the online streaming platform provided by the method have the advantage that they provide vehicles with the option of operating with a level of automation which is higher than that initially provided for the vehicle. This option is available for all vehicles and, in fact, regardless of whether other vehicles having a higher level of automation are located in the immediate surroundings of the vehicle. The online streaming platform may, due to a multitude of collected and processed data and information, also provide a driver with a higher level of automation when no other vehicles having a higher level of automation are currently located in the vicinity of the vehicle.

In conjunction with the present disclosure, data crowdsourcing can be used. To do this, crowdsourced sensing is used, which is understood to mean a sensor technology in which data are acquired by one or more sensor(s), wherein the sensors are distributed at different geographic positions and the data are hosted via a cloud. The data can be used to generate new data regarding information about users connected to the cloud, or for reporting. In conjunction with the following application, crowdsourced sensing is used to collect and compile sensor data from vehicles having a high level of automation and to provide the data to other vehicles having a lower sensor capability. In so doing, the diversity of sensors of the other vehicles in the same geographic area is used.

In this context, OG maps (Occupancy Grid maps) can also be provided in real time for use by other vehicles. OG maps of a plurality of vehicles can be fused, i.e., connected to each other or combined, by means of a model. The activation of the online navigation system having a higher level of automation can be linked to the condition that the OG map available online continuously includes all necessary information for driving at the higher level of automation. A use of the online navigation system for emergency functions, such as an automated emergency braking function for collision avoidance, can be ruled out, in principle.

A global dynamic occupancy map can be generated on the basis of the transmitted data. On the basis of the generated global dynamic occupancy map, local dynamic occupancy maps can be generated and the generated local dynamic occupancy maps can be provided, for example, on demand, to a vehicle for use, for example, within the scope of at least semi-autonomous navigation. The local dynamic occupancy maps can be transmitted to a vehicle or can be retrievable and/or usable by a vehicle.

In another variant, a global dynamic occupancy map is generated on the basis of the transmitted data. On the basis of the generated global dynamic occupancy map, geographic zones in which navigation with a certain, for example, established and/or defined, level of automation is available, can be ascertained. Subsequently, data regarding the ascertained geographic zones can be provided, for example, on demand, to a vehicle for use, for example, within the scope of autonomous or semi-autonomous navigation. The data regarding the ascertained geographic zones can be transmitted to a vehicle or can be retrievable and/or usable by a vehicle. The geographic zones can be designed as local dynamic geographic zones.

Optionally, a global dynamic occupancy map can be generated on the basis of the transmitted data, collaborative traffic rules can be ascertained, in particular determined and/or established, on the basis of the generated global dynamic occupancy map, and data regarding the ascertained collaborative traffic rules can be provided, for example, on demand, to a vehicle for use, preferably within the scope of semi-autonomous and autonomous navigation. The data regarding the ascertained collaborative traffic rules can be transmitted to a vehicle or can be retrievable and/or usable by a vehicle.

Data from vehicles and infrastructure sensors transmitted to the online streaming platform can be fused simultaneously and/or in parallel, and/or processed at the same time. In other words, all collected data can be combined and/or integrated and/or processed in one single step. This is carried out preferably without arranging or prioritizing the data or the data stream with respect to time. As a result, the reliability of the online streaming platform and its usability and availability for vehicles is improved. In particular, a very high level of reliability of the position of static objects shown in the generated global dynamic occupancy map is achieved. Moreover, the response time of the online streaming platform is reduced.

A computer-implemented method according to the disclosure includes commands, which, when the program is run by a computer, prompt the computer to carry out one of the above-described methods. The computer program product according to the disclosure includes commands, which, when the program is run by a computer, prompt the computer to carry out one of the above-described methods. The computer program product according to the disclosure is stored on the computer-readable data carrier according to the disclosure. The data carrier signal according to the disclosure transmits the computer program product according to the disclosure. The computer-implemented method according to the disclosure and a computer program product according to the invention have the aforementioned features and advantages.

Overall, the present disclosure has the advantage that, due to the common use of data and information, energy can be conserved in the particular vehicles in that, for example, computing power, in particular for creating occupancy maps (OG maps), can be reduced. In addition, individual sensors can be occasionally switched off in that corresponding available data of an online platform are used. In addition, the range of electric vehicles can be increased by means of the present invention. Moreover, costs can be reduced for the user in that, instead of possible acquisition costs for a more highly equipped vehicle, only usage fees are incurred for a corresponding service for occasionally increasing the level of automation of the existing vehicle or of a lesser equipped vehicle to be acquired.

### BRIEF SUMMARY OF THE DRAWINGS

The disclosure is explained in greater detail in the following on the basis of exemplary embodiments and with reference to the accompanying figures. Although the disclosure is illustrated and described in detail by means of the preferred exemplary embodiments, the invention is not limited by the described examples and other variations can be derived by a person skilled in the art without departing from the scope of protection of the invention.

The figures are not necessarily detailed and true to scale and can be enlarged or reduced in order to provide a better overview. Therefore, the functional details disclosed here are to be understood as not limiting, but rather as a clear basis that provides a person skilled in the art in this field of technology with instruction for using the present invention in many different ways.

The expression “and/or” utilized here, when used in a sequence of two or more elements, means that each of the listed elements can be used alone, or any combination of two or more of the listed elements can be used. If, for example, a composition is described, which contains the components A, B, and/or C, the composition can contain A alone; B alone; C alone; A and B in combination; A and C in combination; B and C in combination; or A, B, and C in combination.

FIG. 1 schematically shows a roadway with vehicles which are equipped with different levels of automation.

FIG. 2 schematically shows a first variant of a method for operating a vehicle in the form of a flow chart.

FIG. 3 schematically shows a second variant of a method for operating a vehicle in the form of a flow chart.

FIG. 4 schematically shows a vehicle having a control device.

FIG. 5 schematically shows a method for providing an online streaming platform for use for a method for operating a vehicle in the form of a block diagram.

### DESCRIPTION

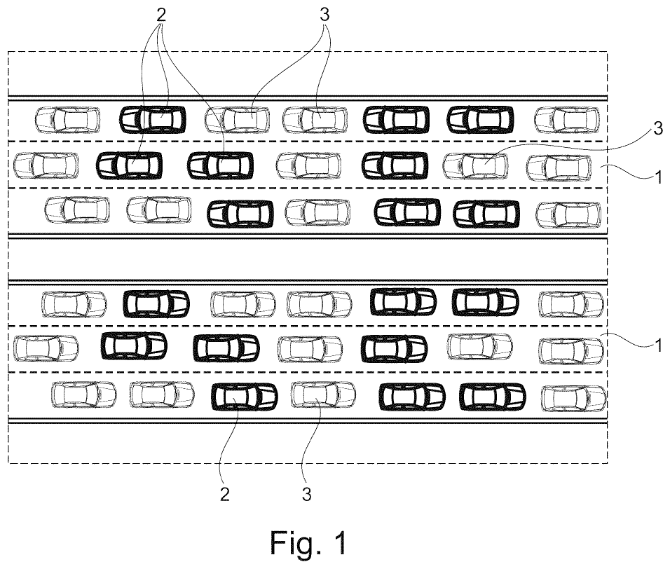

FIG. 1 schematically shows a roadway 1 in the form of a three-lane highway in a top view. A multitude of vehicles are in a traffic jam. A first subset of vehicles 2 is equipped with a low level of automation, for example, a level of automation which is below an established threshold. In the example shown, it is assumed that the vehicles 2 have an L2 level of automation or lower. A second subset of vehicles 3 is equipped with a high level of automation, for example, a level of automation which is above an established threshold. In the example shown, it is assumed that the vehicles 3 have an L3 level of automation or higher.

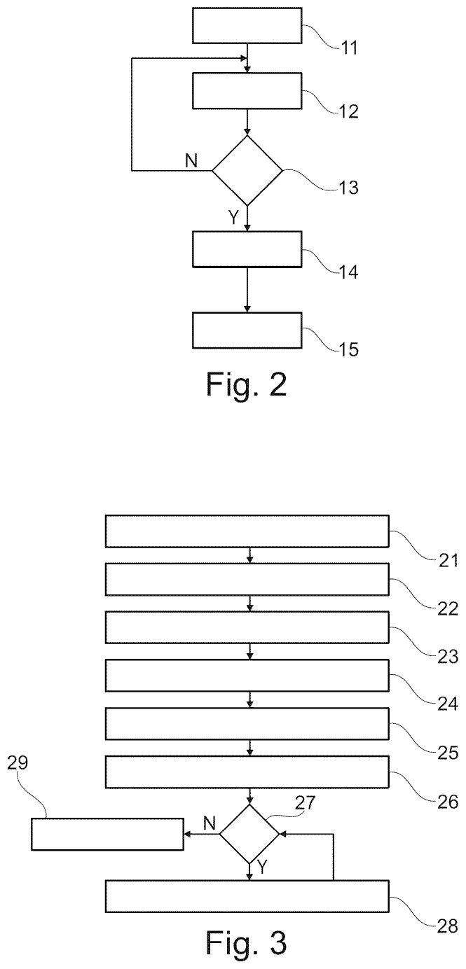

FIG. 2 schematically shows a first variant of a method for operating a vehicle in the form of a flow chart. The vehicle 2 has an established level of automation, for example, L2.

In step 11, an online-provided or online-available, for example, a cloud-based, navigation system having a level of automation which is higher than the level of automation of the vehicle is started. In other words, the online-provided or online-available navigation system is designed to navigate a vehicle with a higher level of automation (for example, L3 or L4) than that which corresponds to the vehicle equipment (for example, L2). In order to start the online-provided or online-available navigation system, a data connection to the navigation system is preferably established. In step 12, geographic zones or regions, i.e., AV zones, which are available in the navigation system and in which navigation, for example, online-based navigation, with a higher level of automation is available, are ascertained, retrieved, and displayed.

In step 13, a check is carried out to determine whether the vehicle 2 is located in a geographic zone which is available for navigation with a higher level of automation. If this is not the case, the method jumps back to step 12 or is terminated. If the vehicle 2 is located in an ascertained geographic zone or an ascertained region in which navigation with a higher level of automation is available, i.e., for example, in an AV zone suggested by the navigation system, in step 14, the online-provided or online-available, for example, cloud-based, navigation system having a higher level of automation than that of the vehicle 2 is activated.

Then, in step 15, navigation of the vehicle 2 with a higher level of automation, for example, L3 or L4, is started, wherein data of the online navigation system are used. In this context, data of the online navigation system can be accessed and/or retrieved.

FIG. 3 schematically shows a second variant of a method for operating a vehicle 2 in the form of a flow chart. The variants shown in FIGS. 2 and 3 can be combined with one another and complement one another.

In step 21 in FIG. 3, a user or a driver starts a cloud-based L3 navigation system. The vehicle 2 connects to the cloud and waits for a response. The L3 navigation system ascertains the available AV zones and displays these to the driver on a screen. Moreover, the navigation system displays an optimal route on which the use of a L3 navigation is maximized.

In step 22, the vehicle 2 enters the AV zone in which a sensor service of the L3 navigation system is available. In step 23, the driver is informed of this and waits for activation of the cloud-based L3 navigation system. In step 24, the driver is notified that the L3 navigation system is available. A wait for activation by the driver ensues. In step 25, the L3 navigation system is activated. In step 26, new data are received and autonomous driving at the L3 level of automation is started. The new data are continuously monitored.

In step 27, the connection to the cloud, or to the online L3 navigation system, is monitored. If the connection exists, the autonomous driving is continued in step 28. Moreover, in step 28, current data of the vehicle 2, for example, for tracking the driving maneuver, are uploaded to the cloud. If, in step 27, the connection to the cloud is interrupted, in step 29 the driver is informed of this and is prompted to take over the control of the vehicle 2. Moreover, a safe deactivation of the L3 navigation system is started. If the driver does not respond, an emergency maneuver is started.

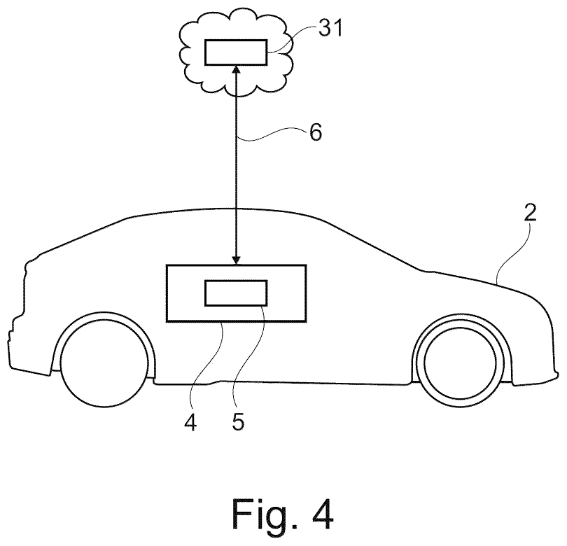

FIG. 4 schematically shows a vehicle 2 with a control device 4. The vehicle 2 has an established level of automation, for example, L2 or L3, or is equipped with same. The control device 4 is designed for the at least semi-automated operation of the vehicle 2 and includes a device 5 for data exchange 6 with an online, for example, cloud-based, navigation system 31. The control device 4 is designed to carry out an above-described method, for example, a method described with reference to FIGS. 2 and/or 3.

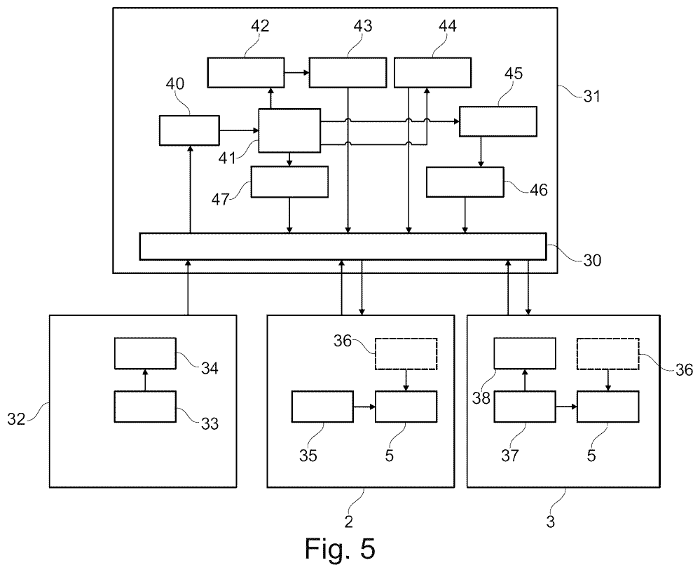

FIG. 5 schematically shows a method for providing an online streaming platform 30 for use as a navigation system 31 for a method for operating a vehicle 2, 3 in the form of a block diagram.

The block 31 indicates a navigation system in the form of an intelligent crowdsourced sensor service with a streaming platform 30. The streaming platform 30 forms the main module for connecting and for handling all streaming clients. The block 32 indicates an infrastructure sensor network which acts as a data producer in the present case. Block 2 indicates a data consumer in the form of a vehicle 2, which is equipped, for example, with an L2 level of automation. Block 3 indicates a data producer in the form of a vehicle 3, which has an L3 or L4 level of automation. In FIG. 5, the data transmission between individual blocks is indicated by arrows.

Data producers are understood in the present case to be all highly equipped vehicles, for example, vehicles with an ADAS3, L3, or L4 equipment. The vehicles should be capable of regularly creating highly efficient occupancy networks with precise localization and a list of all objects identified on the map. Data consumers are understood in the present case to mean all low-equipped vehicles which are equipped with the necessary control interfaces and are capable of expanding automation features by connecting to a sensor platform.

The infrastructure sensor network 32 includes a plurality of sensors 33 and a device 34 for generating a data stream. Data are transmitted from the sensors 33 to the device 34. The network 32 transmits data to the streaming platform 30. The device 34 for generating a data stream can be designed, for example, as streaming client software, which is installed in all vehicles acting as data producers and which is designed to continuously transmit the locally generated dynamic maps to a sensor platform, for example, the streaming platform 30.

The vehicle 2 includes vehicle sensors 35 for an L2 operation and a control device 5. The control device 5 receives data from the vehicle sensors 35 and from a device for receiving a data stream 36 from the streaming platform 30. The vehicle 2 receives and transmits data to the streaming platform 30. The device 36 for receiving a data stream can be designed, for example, as streaming client software, which is installed in vehicles and which is designed to continuously download data from a sensor platform, for example, the streaming platform 30.

The vehicle 3 includes vehicle sensors 37 for an L3 operation and/or an L4 operation, a control device 5, and a device 38 for generating a data stream. Data are transmitted from the vehicle sensors 37 to the device 38. The control device 5 receives data from the vehicle sensors 37 and a data stream 36 from the streaming platform 30. The vehicle 2 receives and transmits data to the streaming platform 30.

The streaming platform 30 forms an input 40 from the received data streams. On the basis of the input 40, a global dynamic occupancy map is generated by means of a module 41. The module 41 for generating the global dynamic occupancy map is designed to combine and process, in particular fuse, the local information from different data producers with the objective of generating one single map which is continuously updated with local information. The module 41 handles, synchronizes, and solves all types of conflicts between the received information. The objective is to generate a map having the highest definition in real time.

On the basis of the global dynamic occupancy map 41, local occupancy maps are generated on demand by means of a module 42 and, on the basis of the local occupancy maps, dynamic maps 43 adapted to a specific vehicle may be generated as output. In particular, a local map can be generated on the basis of the position of the user and the activated feature, for example, a parking assistant or another driver assistant.

Moreover, AV zones can be ascertained from the global dynamic occupancy map 41 by means of a module 44 and these AV zones can be output as maps. In this context, zones are defined, in which the sensor information is valid and is suitable for driving with a higher level of automation. The corresponding module 44 for generating the AV zones monitors the traffic density at vehicles having a higher, for example, an L3 and/or L4, level of automation, which vehicles are connected to the platform 30. Moreover, the module 44 can check and weight each data producer.

In addition, on the basis of the global dynamic occupancy map, local collaborative traffic rules or behavior rules can be ascertained by means of a module 45. On the basis of the collaborative traffic rules or behavior rules, cooperative route planning 46 can be carried out and, on the basis thereof, target trajectories can be generated as output. The objective is to share cooperative traffic rules or behavior rules between the drivers or to recommend these to the drivers, or the consumers. This additional information, combined with the occupancy map, is intended to help the drivers or users make the right decisions.

On the basis of the global dynamic occupancy map, requirements on the data producers are processed and output by means of the handling module 47. The objective is to optimize and prioritize the recommended flow of data and information through the streaming platform 30. The module requires, for example, new or additional data from the data producers in accordance with the particular state of the global dynamic occupancy map.

A provided streaming platform, as is illustrated in FIG. 5, can be used as a navigation system for carrying out an above-described method for operating a vehicle.

### LIST OF REFERENCE SIGNS

1 roadway
2 vehicle with low level of automation
3 vehicle with high level of automation
4 control device
5 device for exchanging data with an online navigation system
6 data exchange
11 starting an online navigation system with a level of automation which is higher than the level of automation of the vehicle
12 ascertaining, retrieving, and displaying available geographic zones in which navigation with a higher level of automation is available
13 Is the vehicle in a geographic zone which is available for navigation with a higher level of automation?
14 activating the online navigation system with a higher level of automation
15 starting navigation of the vehicle with a higher level of automation
21 starting L2 navigation system, displaying available AV zones
22 vehicle enters the AV zone in which a sensor service of the L3 navigation system is available
23 notifying the driver that the vehicle has entered the AV zone
24 notifying the driver about the availability, waiting for activation
25 L3 navigation system activated
26 receiving and monitoring data, starting autonomous driving
27 checking the connection to the cloud
28 continuing autonomous driving and uploading data to the cloud
29 notifying the driver, deactivating autonomous driving, starting emergency maneuver if necessary
30 online streaming platform
31 crowdsourced sensor service
32 infrastructure sensor network
33 sensors
34 device for generating a data stream
35 L2 vehicle sensors
36 device for receiving a data stream
37 L3/L4 vehicle sensors
38 device for generating a data stream
40 input
41 module for generating a global dynamic occupancy map
42 module for generating local occupancy maps
43 outputting individually adapted, dynamic maps
44 module for generating AV zones
45 module for ascertaining locally collaborative traffic rules or behavior rules
46 cooperative route planning
47 handling module
Y yes
N no

1-17. (canceled)

18. A method for operating a vehicle which has an established level of automation, comprising:
starting an online navigation system with a level of automation which is higher than the level of automation of the vehicle;
ascertaining, retrieving, and displaying available geographic zones in which navigation with a higher level of automation is available;
upon determining that the vehicle is located in a geographic zone in which navigation with the higher level of automation is available, activating the online navigation system having a higher level of automation; and
starting navigation of the vehicle with the higher level of automation using data of the online navigation system.

19. The method of claim 18, further comprising:
monitoring the connection to the online navigation system;
upon the connection being interrupted, prompting the driver of the vehicle to take over the control of the vehicle according to the level of automation of the vehicle; and
terminating and/or deactivating the navigation of the vehicle with the higher level of automation.

20. The method of claim 19, further comprising:
upon ascertaining that the driver does not take over the control, starting at least one established emergency maneuver.

21. The method of claim 18, further comprising:
ascertaining a route to a defined destination that maximizes and/or optimizes a use of the navigation with a higher level of automation.

22. The method of claim 18, further comprising:
transmitting to the online navigation system current data regarding the immediate surroundings of the vehicle collected by the vehicle.

23. The method of claim 18, wherein:
the vehicle is provided with data for navigating the vehicle with the higher level of automation, which data have been adapted to the vehicle by the online navigation system.

24. The method of claim 18, wherein, wherein:
data from vehicles and infrastructure sensors are transmitted to an online streaming platform;
dynamic occupancy maps are generated on the basis of the transmitted data; and
the generated dynamic occupancy maps are provided to a vehicle for use.

25. The method of claim 24, further comprising:
generating global dynamic occupancy map based on the transmitted data;
generating, based on the generated global dynamic occupancy map, local dynamic occupancy maps and/or geographic zones in which navigation with a certain level of automation is available; and
providing the generated local dynamic occupancy maps and/or geographic zones to the vehicle.

26. The method of claim 24, further comprising:
generating global dynamic occupancy map based on the transmitted data;
ascertaining collaborative traffic rules based on the generated global dynamic occupancy map; and
data regarding the ascertained collaborative traffic rules are provided to a vehicle for use.

27. The method of claim 24, wherein:
data from vehicles and infrastructure sensors transmitted to the online streaming platform are fused simultaneously and/or in parallel.

28. A system, comprising a control device for the at least semi-automated operation of a vehicle which has an established level of automation, wherein the control device is configured to:
start an online navigation system with a level of automation which is higher than the level of automation of the vehicle;
ascertain, retrieve, and display available geographic zones in which navigation with a higher level of automation is available;
upon determining that the vehicle is located in a geographic zone in which navigation with the higher level of automation is available, activate the online navigation system having a higher level of automation; and
start navigation of the vehicle with the higher level of automation using data of the online navigation system.

29. The system of claim 28, wherein the control device is further configured to:
monitor the connection to the online navigation system;
upon the connection being interrupted, prompt the driver of the vehicle to take over the control of the vehicle according to the level of automation of the vehicle; and
terminate and/or deactivate the navigation of the vehicle with the higher level of automation.

30. The system of claim 29, wherein the control device is further configured to:
upon ascertaining that the driver does not take over the control, start at least one established emergency maneuver.

31. The system of claim 28, wherein the control device is further configured to:
ascertain a route to a defined destination that maximizes and/or optimizes a use of the navigation with a higher level of automation.

32. The system of claim 28, wherein the control device is further configured to:
transmit to the online navigation system current data regarding the immediate surroundings of the vehicle collected by the vehicle.

33. The system of claim 28, wherein:
the vehicle is provided with data for navigating the vehicle with the higher level of automation, which data have been adapted to the vehicle by the online navigation system.

34. The system of claim 28, wherein:
data from vehicles and infrastructure sensors are transmitted to an online streaming platform;
dynamic occupancy maps are generated on the basis of the transmitted data; and
the generated dynamic occupancy maps are provided to a vehicle for use.

35. The system of claim 34, wherein the online streaming platform is configured to:
generate a global dynamic occupancy map based on the transmitted data;
generate, based on the generated global dynamic occupancy map, local dynamic occupancy maps and/or geographic zones in which navigation with a certain level of automation is available; and
provide the generated local dynamic occupancy maps and/or geographic zones to the vehicle.

36. The system of claim 34, wherein the online streaming platform is configured to:
generate a global dynamic occupancy map based on the transmitted data;
ascertain collaborative traffic rules based on the generated global dynamic occupancy map; and
data regarding the ascertained collaborative traffic rules are provided to a vehicle for use.

37. The system of claim 34, wherein:
data from vehicles and infrastructure sensors transmitted to the online streaming platform are fused simultaneously and/or in parallel.
